(19) United States
(12) Patent Application Publication
(10) Pub. No.: US 2017/0260612 A1
(43) Pub. Date: Sep. 14, 2017

(54) Heat Exchanger, Use of an Aluminium Alloy and of an Aluminium Strip as well as a Method for the Production of an Aluminium Strip

(71) Applicants: Hartmut Janssen, Hilden (DE); Gerhard Bermig, Horneburg (DE); Volker Saß, Niederkassel-Mondorf (DE); Stefan Schlüter, Dusseldorf (DE)

(72) Inventors: Hartmut Janssen, Hilden (DE); Gerhard Bermig, Horneburg (DE); Volker Saß, Niederkassel-Mondorf (DE); Stefan Schlüter, Dusseldorf (DE)

(73) Assignee: Hydro Aluminium Rolled Products GmbH, Grevenbroich (DE)

(21) Appl. No.: 15/603,714

(22) Filed: May 24, 2017

Related U.S. Application Data
(63) Continuation of application No. PCT/EP2015/077653, filed on Nov. 25, 2015.

(30) Foreign Application Priority Data
Nov. 27, 2014 (DE) 10 2014 117 384.8
Mar. 10, 2015 (EP) 15158514.8

(51) Int. Cl. C22F 1/043; B22D 7/00; B23K 35/28; F28F 21/08; F28D 1/02; F28D 1/053; F28F 1/02; F28F 1/12; C22C 21/02; B23K 1/00

(52) U.S. Cl. CPC C22F 1/043; C22C 21/02; B22D 7/005; B23K 35/288; B23K 1/0012; F28D 1/0233; F28D 1/05383; F28F 1/022; F28F 1/126; F28F 21/084; F28F 2275/04

(57) ABSTRACT

Provided is a heat exchanger, in particular for motor vehicles, with at least one exchanger tube of an aluminium alloy and with at least one component connected fluidically to the exchanger tube, wherein the exchanger tube and the component (14, 16) are connected to one another by way of a common soldered connection and wherein the component connected to the exchanger tube has a core layer of an aluminium alloy with the following composition: Si: max. 0.7% by weight, Fe: max. 0.70% by weight, Cu: max. 0.10% by weight, Mn: 0.9-1.5% by weight, Mg: max. 0.3% by weight, Cr: max. 0.25% by weight, Zn: max. 0.50% by weight, Ti: max. 0.25% by weight, Zr: max. 0.25% by weight, unavoidable impurities individually max. 0.05% by weight, altogether max. 0.15% by weight, the remainder aluminium.

### CROSS-REFERENCE TO RELATED PATENT APPLICATIONS

This patent application is a continuation of PCT/EP2015/077653, filed Nov. 25, 2015, which claims priority to German Application No. 10 2014 117 384.8, filed Nov. 27, 2014, and European Application No. 15158514.8, filed Mar. 10, 2015, the entire teachings and disclosure of which are incorporated herein by reference thereto.

### FIELD OF THE INVENTION

The invention relates to a heat exchanger, in particular for motor vehicles, with at least one exchanger tube made of an aluminium alloy and with at least one component connected in fluid communication to the exchanger tube, wherein the exchanger tube and the component are connected to one another by way of a common brazed connection. The invention also relates to the use of an aluminium alloy or of an aluminium strip with a core layer of this aluminium alloy for the production of a manifold or a tubesheet for a brazed heat exchanger as well as a method for the production of a roll-clad aluminium strip, in particular for the previously mentioned use.

### BACKGROUND OF THE INVENTION

A heat exchanger serves to transfer thermal energy from one medium flow to another medium flow. For this purpose, the heat exchanger has at least one exchanger tube designed to be flowed through by a first medium flow during operation, with said medium flow being in thermal contact with a second medium flow by way of the exchanger tube. To this end, the second medium flow can flow in particular around the exchanger tube during operation. For improved heat transfer, a heat exchanger is typically constructed such that a large surface that can be used for the heat transfer is provided. For this purpose, a wound exchanger tube, an exchanger tube with a plurality of channels and/or an exchanger tube bundle with a plurality of exchanger tubes can for example be used. Additionally or alternatively, cooling bodies such as fins can be brazed on the exchanger tube in order to further enlarge the thermal contact surface.

In addition to the at least one exchanger tube, heat exchangers have additional components from which a medium flow flows into the exchange tube or into which a medium flow flows from the exchanger tube during operation. Components, which are connected to one end of the exchanger tube in order to introduce the medium flow into the exchanger tube or collect the medium flow leaving the exchange tube, respectively, are also referred to as manifolds or tubesheets. A manifold is in particular understood as a body closed in the circumferential direction, typically in the form of a tube, which has perforations for the connection of exchanger tubes of a heat exchanger. A tubesheet is in particular understood as a body that is not completely closed in the circumferential direction, for example with a half tube cross section, which is supplemented by an additional component, for example by a plastic plate, to form a body that is closed in the circumferential direction. The tubesheet also has perforations for the connection of exchanger tubes of a heat exchanger.

Corrosion by environmental influences poses a significant problem in brazed heat exchangers of aluminium, in particular for applications in the automobile field.

Since alloys, typically optimised for the respective application, with different chemical composition and accordingly different corrosion potential are used for the individual components of a heat exchanger such as fins, exchanger tubes, manifolds, etc., there is a coupled galvanic corrosion system in the heat exchanger.

This situation is usually taken into account in material selection in that aluminium materials with a comparatively noble corrosion potential are used for particularly critical components, such as for example for thin, medium-carrying tubes, while components less critical for the operation of the heat exchanger, such as for example fins, are made from aluminium materials with a baser corrosion potential. As a result, the less critical components of the heat exchanger are initially corrosively attacked during use such that the service life of the heat exchanger, i.e. the time until a leak occurs, can be significantly extended.

Extruded multi-chamber tubes, so-called MPEs, have been largely established for condensers of air-conditioning systems for the cooling medium-carrying tubes in the cooler network. In order to limit the pressing forces during extrusion in the production process of MPEs, typical aluminium alloys for MPEs typically contain notably fewer alloy elements (such as e.g. Mn, Si or Cu) than the alloys for rolling common for other heat exchanger components, which alloys are typically based on Al—Mn alloys (alloys of the type EN-AW 3xxx).

This applies in particular for the components such as manifolds or tubesheets with which the MPEs are brazed in the heat exchanger. As a result, the corrosion potential of the MPEs is in many cases lower than that of the manifold or tubesheet so that the MPE preferably corrodes in the region between the brazed connection to the manifold and the first air fin.

In order to avoid this local corrosion of the MPEs, different counter measures are known which are also partly combined with one another.

It is thus known to apply a zinc-containing coating on the MPE, for example by thermal spraying or by applying a zinc-containing flux coating. The application of zinc on the surface of the MPEs reduces the corrosion potential of the aluminium material locally such that a corrosion attack preferably develops laterally parallel to the tube surface. A local corrosion attack, so-called pitting, can be thereby prevented such that the service life of the heat exchanger is notably increased.

It is also known to use a zinc-containing brazing material on the manifold or the tubesheet. The corrosion potential on the surface of the manifold or the tubesheet is thereby significantly lowered such that it is ideally below the corrosion potential of the MPEs after brazing, which is then anodically protected by the manifold or the tubesheet. However, the previously mentioned measures have the disadvantage that the distribution of the zinc in the brazed heat exchanger is difficult to control. Zinc has a particularly high diffusion speed in aluminium. During the brazing process at temperatures in the range of typically 600° C., zinc can travel comparatively wide diffusion paths depending on the duration of the brazing process. In unfavourable cases, a high concentration of zinc within the brazed connections between the MPE and the manifold or also between the MPE and a cooling fin may occur as a result. As a result, these brazed connections may become the most anodic region of the heat exchanger, i.e. the region with the lowest corrosion potential, and thus preferably corrode which may lead to a high performance loss of the heat exchanger (in the case of corrosion of the brazed connection between MPE and cooling fin) or even to the failure of the heat exchanger (in the case of corrosion of the brazed connection between MPE and manifold).

In order to still be able to avoid such a performance loss or even a premature failure of the heat exchanger, it would be necessary to precisely set the zinc content in each component for each application and as a function of the respective brazing conditions. However, this requires significant effort and prevents the use of standardised materials.

Against this background, the object of the present invention is to provide a material concept for a brazed heat exchanger with which the previously described corrosion problems can be reduced and which is usable as universally as possible.

### BRIEF SUMMARY OF THE INVENTION

According to the invention, this object is at least partly achieved with a heat exchanger, in particular for motor vehicles, with at least one exchanger tube made of an aluminium alloy and with at least one component connected in fluid communication to the exchanger tube, with the exchanger tube and the component being connected to one another by way of a common brazed connection in that the component connected to the exchanger tube has a core layer of an aluminium alloy with the following composition:
Si: max. 0.7% by weight, preferably 0.10-0.7% by weight, in particular 0.50-0.7% by weight,
Fe: max. 0.7% by weight, preferably 0.10-0.50% by weight, in particular 0.15-0.40% by weight,
Cu: max. 0.10% by weight, preferably max. 0.05% by weight, in particular max. 0.03% by weight,
Mn: 0.9-1.5% by weight, preferably 1.2 to 1.5% by weight,
Mg: max. 0.30% by weight, preferably 0.01-0.15% by weight, in particular 0.01-0.10% by weight,
Cr: max. 0.25% by weight, preferably 0.10 to 0.20% by weight,
Zn: max. 0.50% by weight, preferably max. 0.25% by weight, in particular max. 0.10% by weight,
Ti: max. 0.25% by weight, preferably max. 0.05% by weight,
Zr: max. 0.25% by weight, preferably max. 0.05% by weight,
unavoidable impurities individually max. 0.05% by weight, in total max. 0.15% by weight, remainder aluminium.

An exchanger tube is in the present case understood as pipe or tube designed to be flowed through by a first medium flow during operation, with said first medium flow being in thermal contact with a second medium flow by way of the exchanger tube. The heat exchanger has at least one, preferably a plurality of, for example at least five, exchanger tubes.

At least one component is connected in fluid communication to the exchanger tube. This is understood to mean that the component is connected to at least one end of the exchanger tube in such a way that a medium flow flowing through the exchanger tube during operation also at least partly flows through the component. The component can for example be a manifold or a tubesheet to which one or a plurality of exchanger tubes are connected.

The exchanger tube and the component are connected to one another by way of a common brazed connection. The brazed connection is in particular a hard brazed connection, i.e. a brazed connection which was generated at brazing temperatures of more than 450° C. The exchanger tube and the component are thus in direct contact via the brazed connection such that the exchanger tube and the component form a coupled galvanic corrosion system.

In the context of the invention, it has now been found that corrosion problems occurring with brazed heat exchangers can be reduced by using a component with a core layer of the previously described aluminium alloy for the component connected to the exchanger tube. The component may in particular be a clad component with a core later of the previously mentioned alloy and a cladding layer clad onto the core layer. However, an unclad component may also be used. The term “core layer” is in the present case used both for clad and unclad components, with the core layer in the latter case may also be the only layer of the component.

By using this alloy for the core layer, said core layer has a lower corrosion potential in the brazed state and is thus baser than the majority of the alloys typically used for exchanger tubes, in particular for MPEs. By combining this alloy for the core layer of the component, in particular a manifold or a tubesheet, with the alloy of the exchanger tube, in particular the MPEs, the alloy of the core layer provides galvanic protection for the exchanger tubes.

Thus the use of zinc-containing coatings on the exchanger tube or zinc-containing brazed claddings on the components such as manifolds or tubesheets can be dispensed with or the quantity of zinc used can be at least significantly reduced. Accordingly, the corrosion potential of the core layer in the brazed state is thus preferably lower than the corrosion potential of the exchanger tube of the heat exchanger.

In corrosion tests (sea water acidified test—SWAAT—in accordance with ASTM G85, annex A3), brazed heat exchangers using manifolds or tubesheets of the previously mentioned alloy exhibited notably longer service lives than heat exchangers with manifolds or tubesheets of commercially available core alloys without adapted corrosion potential.

In particular by using the previously mentioned alloy for the core layer of the component, leakages of the exchanger tubes, in particular of MPEs, can be prevented in the region between manifolds and fins adjoined thereto.

Accordingly, the above mentioned object is also at least partly achieved according to the invention by the use of an aluminium alloy or an aluminium strip with a core layer of this aluminium alloy for the production of a component, in particular a manifold or a tubesheet, for a heat exchanger, in particular the previously described heat exchanger, with the component being designed to be connected in fluid communication to an exchanger tube of the heat exchanger and with the aluminium alloy having the following composition:
Si: max. 0.7% by weight, preferably 0.10-0.7% by weight, in particular 0.50-0.7% by weight,
Fe: max. 0.7% by weight, preferably 0.10-0.50% by weight, in particular 0.15-0.40% by weight,
Cu: max. 0.10% by weight, preferably max. 0.05% by weight, in particular max. 0.03% by weight,
Mn: 0.9-1.5% by weight, preferably 1.2 to 1.5% by weight,
Mg: max. 0.30% by weight, preferably 0.01-0.15% by weight, in particular 0.01-0.10% by weight,
Cr: max. 0.25% by weight, preferably 0.10 to 0.20% by weight,
Zn: max. 0.50% by weight, preferably max. 0.25% by weight, in particular max. 0.10% by weight,
Ti: max. 0.25% by weight, preferably max. 0.05% by weight,
Zr: max. 0.25% by weight, preferably max. 0.05% by weight,
unavoidable impurities individually max. 0.05% by weight, in total max. 0.15% by weight, remainder aluminium.

The previously described alloy is characterised in particular in that the alloy elements Zn and Mg usually added to a considerable extent to reduce the corrosion potential have been largely dispensed with. Instead, the desired corrosion potential is achieved by careful adjustment of the alloy composition.

The alloy is also characterised in particular by largely dispensing with the alloy element copper which is used with conventional alloys to increase strength and to control the corrosion potential. Further, in particular, the content of the alloy element manganese in solution in the brazed state is minimised. This can in particular also be achieved by adjusting the contents of the alloy elements Mn, Si and Fe in combination with the temperature control in the case of homogenisation annealing and pre-heating for hot rolling.

In spite of dispensing with the strength-increasing element copper, sufficient strength values can still be achieved with the previously described alloy, in particular comparable strength values to conventional copper-containing alloys. As a result, the described alloy can readily replace alloys used hitherto both in heat exchangers (e.g. condensers) with extruded tubes (MPEs) and in heat exchangers with tubes consisting of rolled aluminium sheet metal.

It has further been found that the favourable combination of properties, i.e. a low corrosion potential with simultaneously good strength, can be achieved particularly well with clad aluminium strips by carefully adjusting the alloy composition and the production process.

Accordingly, the above mentioned object is also at least partly achieved according to the invention by a method for the production of an aluminium strip, in particular for the previously mentioned use, with the following steps:
casting a rolling ingot in the DC method of an aluminium alloy with the following composition:
   Si: max. 0.7% by weight, preferably 0.10-0.7% by weight, in particular 0.50-0.7% by weight,
   Fe: max. 0.7% by weight, preferably 0.10-0.50% by weight, in particular 0.15-0.40% by weight,
   Cu: max. 0.10% by weight, preferably max. 0.05% by weight, in particular max. 0.03% by weight,
   Mn: 0.9-1.5% by weight, preferably 1.2 to 1.5% by weight,
   Mg: max. 0.30% by weight, preferably 0.01-0.15% by weight, in particular 0.01-0.10% by weight,
   Cr: max. 0.25% by weight, preferably 0.10 to 0.20% by weight,
   Zn: max. 0.50% by weight, preferably max. 0.25% by weight, in particular max. 0.10% by weight,
   Ti: max. 0.25% by weight, preferably max. 0.05% by weight,
   Zr: max. 0.25% by weight, preferably max. 0.05% by weight,
   unavoidable impurities individually max. 0.05% by weight, in total max. 0.15% by weight, remainder aluminium.
homogenising the rolling ingot by means of an annealing treatment at a temperature in the range of 540° C. and 620° C., preferably in the range of 540° C. and 600° C., and a hold time at the target temperature between 4 and 12 hours,
hot rolling the rolling ingot to form a hot strip, in particular to a hot strip thickness in the range of 2.0 to 10 mm, preferably in the range of 3 to 7 mm,
cold rolling the hot strip to a final thickness with optional intermediate annealing at a temperature in the range of 300° C. to 450° C., preferably in the range of 300° C. to 400° C., with the final thickness of the cold strip preferably in the range of 0.1 to 5 mm, particularly preferably in the range of 0.8 to 3 mm, in particular in the range of 1.0 to 2.5 mm.

According to an alternative embodiment of the invention, the previously described method can also be carried out without homogenising the rolling ingot.

It has been determined that this production method in combination with the previously described alloy leads to an aluminium strip whose core layer has good strength and simultaneously a low corrosion potential.

The rolling ingot is preferably provided with a cladding coat prior to hot rolling. The cladding coat is thereby clad onto the rolling ingot during subsequent hot rolling. The rolling ingot can be provided with a cladding coat on one or both sides. The rolling ingot can in particular be provided with a cladding coat of a brazing alloy on one side, which brazing alloy may be for example be an aluminium alloy with a Si content of between 7 and 12% by weight. Suitable brazing alloys are for example EN-AW 4343 or EN-AW 4045. Alternative alloys such as e.g. EN-AW 4104 are also possible for a possible vacuum brazing process.

Alternatively or additionally, one or a plurality of corrosion protection layers, for example of EN-AW 1050 or EN-AW 7072 can also be clad onto the rolling ingot. Corrosion protection layers of this type can for example be clad on the side which is in contact with a corrosive medium during subsequent use. The corrosion protection can also be ensured by such a corrosion protection layer even when using an unsuitable cooling medium. This embodiment is therefore in particular suitable for coolant coolers. If the aluminium strip is for example used for the production of a manifold, then the corrosion protection layer is preferably arranged on the inside of the tube.

The individual steps of the previously described method are described in greater detail below:

Firstly, a rolling ingot is cast from the previously described alloy in the direct chill (DC) method. In the DC method, the liquid metal is cast by way of a preferably cooled mould to form a rolling ingot. The resulting rolling ingot is then directly further cooled, for example by applying water.

The homogenisation of the rolling ingot is carried out by an annealing treatment at a temperature of between 540° C. and 620° C., preferably between 540° C. and 600° C., and a hold time at the target temperature of between 4h and 12h. The precipitation condition of the material is substantially set by the homogenisation which in turn influences the corrosion potential of the material.

Alternatively, the homogenisation of the rolling ingot can also be omitted in order to achieve a higher strength of the material in the brazed state.

For optimal roll cladding, the core bar is provided with a cladding coat on one or both sides. The layers arranged on top of one another are also referred to as cladding packet. The thickness of the cladding coat is preferably in each case between 5% and 20% of the overall thickness of the cladding packet.

During hot rolling, the rolling ingot or the cladding packet is rolled, respectively, to a thickness of preferably 2.0 to 10 mm, in particular 3 to 7 mm. For hot rolling, the rolling ingot or the cladding packet, respectively, is in particular initially pre-heated to a temperature of between 450° C. and 480° C. and held at the target temperature for approx. 3 to 10 hours. Higher pre-heating temperatures than 480° C. and longer hold times than 10 hours should be avoided in order to not significantly change the precipitation condition set during homogenisation.

The hot strip is rolled during cold rolling to the required final thickness, preferably to a thickness of between 0.1 and 5 mm, particularly preferably between 0.8 and 3 mm, in particular between 1.0 mm and 2.5 mm. Depending on the applications however, even lower or greater final thicknesses are possible or reasonable.

If a state hard as rolled, e.g. H14 (DIN EN 515), is required in the final state, a recrystallising annealing of the cold strip is preferably carried out at an intermediate thickness at temperatures of between 300° C. and 450° C., in particular between 300° C. and 400° C. The intermediate thickness depends on the required final thickness, the mechanical strength of the material can be set via the precise final rolling reduction degree. For a state of H14, e.g., a final rolling reduction degree in the range of 25% to 30%, for example of 30%, is reasonable in order to achieve a favourable combination of strength in the delivered state and formability. The final rolling reduction degree in contrast typically has only little or no influence on the corrosion potential in the brazed state.

For a material in the soft-annealed state O (DIN EN 515), soft annealing preferably takes place at final thickness at a temperature of between 300° C. and 450° C., in particular between 300° C. and 400° C. The method for a material in the soft-annealed state is also preferably carried out with homogenisation of the rolling ingot. Alternatively, a state H24 (DIN EN 515) can be set by final annealing at temperatures of between 240° C. and 350° C. If high requirements are placed on the formability of the aluminium strip, in particular for the production of a component of the heat exchanger of the aluminium strip, then a state O (also called O temper) is preferably set during the production process of the aluminium strip. For the use of the aluminium strip for the production of tubes, in particular a manifold, as a component of the heat exchanger, a state H24 or H14 is preferably set during the production process. Such a state of the aluminium strip in particular facilitates the punching of slots for the connection of the exchanger tubes. It has been found that a concluding heat treatment such as final or soft annealing has no significant influence on the corrosion potential after brazing.

The aluminium alloy of which the core layer of the component connected to the exchanger tube or the aluminium strip to be used for the production thereof consists or from which the rolling ingot is cast for the production of the aluminium strip, has the following composition:
Si: max. 0.7% by weight, preferably 0.10-0.7% by weight, in particular 0.50-0.7% by weight,
Fe: max. 0.7% by weight, preferably 0.10-0.50% by weight, in particular 0.15-0.40% by weight,
Cu: max. 0.10% by weight, preferably max. 0.05% by weight, in particular max. 0.03% by weight,
Mn: 0.9-1.5% by weight, preferably 1.2 to 1.5% by weight,
Mg: max. 0.30% by weight, preferably 0.01-0.15% by weight, in particular 0.01-0.10% by weight,
Cr: max. 0.25% by weight, preferably 0.10 to 0.20% by weight,
Zn: max. 0.50% by weight, preferably max. 0.25% by weight, in particular max. 0.10% by weight,
Ti: max. 0.25% by weight, preferably max. 0.05% by weight,
Zr: max. 0.25% by weight, preferably max. 0.05% by weight,
unavoidable impurities individually max. 0.05% by weight, in total max. 0.15% by weight, remainder aluminium.

The significance of the individual alloy components is described below.

Silicon together with manganese forms precipitation phases of the so-called a phase (Al₁₅sMn₄Si₂) in the course of the production process. This reduces the content of manganese being in solution in the matrix and thus influences the corrosion potential in the desired direction and also increases the mechanical strength through precipitation hardening. Excessively high contents would excessively reduce the melting point of the alloy. The Si content of the aluminium alloy is thus max. 0.7% by weight. In order to simultaneously achieve a desired corrosion potential, the Si content of the aluminium alloy is preferably 0.10-0.7% by weight, particularly preferably 0.50-0.7% by weight.

High iron contents negatively affect the corrosion behaviour and also bind silicon in the form of intermetallic phases so that the effect of the bond formation between silicon and manganese, as previously described for silicon, is limited. The Fe content of the aluminium alloy is thus limited to max. 0.7% by weight, preferably even to 0.40% by weight. The aluminium alloy preferably has a Fe content in the range of 0.10 -0.50% by weight, in particular of 0.15-0.40% by weight. A lower Fe content than 0.15% by weight or even 0.10% by weight would very significantly limit the selection of usable raw materials (primary aluminium and scrap) and thus increase the raw material costs. With a Fe content in the range of 0.10-0.50% by weight, in particular 0.15-0.40% by weight, a particularly good compromise for good corrosion behaviour, on the one hand, and economic efficiency, on the other hand, is achieved.

Copper pushes the corrosion potential of the alloy strongly into a positive and thus undesirable direction. The Cu content of the aluminium alloy is thus limited to unavoidable traces of max. 0.10% by weight, preferably even max. 0.05% by weight. Since copper can also diffuse from the core layer material to the region of brazed connections, in particular fillet welds, and favour corrosion in this region, the Cu content of the alloy is further preferably limited even to max. 0.03% by weight.

Manganese contributes to the increase in strength. The Mn content of the aluminium alloy is thus at least 0.9% by weight. Excessively high contents of manganese in solution however also push the corrosion potential in an undesired positive direction such that the Mn content of the alloy is max. 1.5% by weight. The Mn content is in particular adapted to the Si content of the alloy. Mn thus forms intermetallic precipitation phases with Si and Al during the homogenisation annealing or the pre-heating for hot rolling, repsectively. As a result, the Mn content in solution is reduced and the corrosion potential is pushed into the desired direction. A ratio of Mn:Si in the range of 1.7 to 3, preferably of 2 to 3, in particular of 2 to 2.5 is thus preferably set. The ratio is based on the proportions in % by weight. The Mn content is preferably in the range of 1.2 to 1.5% by weight. In this range, good strengths were achieved with a simultaneously sufficiently low corrosion potential.

Magnesium increases the strength by solid solution hardening and pushes the corrosion potential into a base, i.e. into the desired direction. However, higher Mg contents negatively affect the brazing behaviour in the normal CAB brazing process (controlled atmosphere brazing). The Mg content of the alloy is thus limited to max. 0.30% by weight, preferably even to max. 0.10% by weight. It has, on the other hand, been found that the strength and the corrosion potential of the core layer can already be set by a targeted addition of a low quantity of Mg in the range of 0.01-0.15% by weight, in particular 0.01-0.10% by weight without the brazing behaviour being negatively influenced.

Chromium increases the strength and in the alloy compensates at least partly the intentional dispensation of copper. However, since undesired coarse intermetallic casting phases can precipitate with higher Cr contents, the Cr content of the alloy is limited to max. 0.25% by weight. The Cr content is preferably 0.10 to 0.20% by weight. A good increase in strength was achieved in this range without significant precipitation of the undesired casting phases.

The Zn content of the alloy is limited to max. 0.50% by weight, preferably to max. 0.25% by weight and particularly preferably even to max. 0.10% by weight due to the previously described corrosion problem through zinc diffusion. Since zinc strongly pushes the corrosion potential into a base direction, it can however be added in small quantities as required for fine adjustment of the corrosion potential, in particular in a range of 0.01-0.10% by weight.

Ti or Zr can be contained up to a content of max. 0.25% by weight in the alloy. The content of Ti and/or of Zr is preferably max. 0.05% by weight.

Different embodiments of the heat exchanger, the use of the aluminium alloy or the aluminium strip, respectively, and the method for the production of the aluminium strip are described below, wherein the individual embodiments in each case can be applied to the heat exchanger, to the use of the aluminium alloy or the aluminium strip, respectively, as well as to the method for the production of the aluminium strip. The embodiments can also be combined with each other.

According to a first embodiment, the aluminium alloy preferably has the following composition:
Si: 0.5-0.7% by weight,
Fe: 0.15-0.40% by weight,
Cu: max. 0.05% by weight, preferably max. 0.03% by weight,
Mn: 1.2 to 1.5% by weight,
Mg: max. 0.10% by weight, preferably 0.01-0.10% by weight,
Cr: 0.10 to 0.20% by weight,
Zn: max. 0.10% by weight,
Ti: max. 0.25% by weight, preferably max. 0.05% by weight,
Zr: max. 0.25% by weight, preferably max. 0.05% by weight,
unavoidable impurities individually max. 0.05% by weight, in total max. 0.15% by weight, remainder aluminium.

An aluminium alloy with good strength and simultaneously sufficiently low corrosion potential is thereby achieved.

According to a further embodiment, the component connected to the exchanger tube is a manifold or a tubesheet. In heat exchangers, exchanger tube are typically connected directly to manifolds or to tubesheets such that these components form a direct galvanically coupled corrosion system with the exchanger tubes. A manifold or a tubesheet with lower corrosion potential than the exchanger tube is consequently well suited to anodically protect the exchanger tube.

According to a further embodiment, the component connected to the exchanger tube has in the brazed state a corrosion potential with respect to a calomel electrode (saturated calomel electrode—SCE) in accordance with ASTM G69 of -740 mV or less. It has been found that with the previously described alloy, in particular in combination with the previously described production method for aluminium strips, a component with such a low corrosion potential can be produced which simultaneously has sufficient strength. With a corrosion potential of -740 mV or less, the component is in particular baser than conventionally used alloys such as for example type EN-AW 3003, EN-AW 3005 or EN-AW 3017, whose corrosion potential is typically in the range of −660 mV to −720 mV.

According to a further embodiment, the exchanger tube is an extruded multi-chamber tube (MPE). Extruded multi-chamber tubes typically have a rather low corrosion potential such that they are particularly vulnerable to corrosion. The use of the previously described alloy for the core layer of the component thus provides significant advantages particularly for heat exchangers with MPEs.

According to a further embodiment, the heat exchanger consists of an aluminium alloy of the type 3xxx. The corrosion potential after brazing is typically between −720 mV and −760 mV for such an alloy. For example, the exchanger tube can consists of an aluminium alloy of the type EN-AW 3102. The corrosion potential is in the range of approx. −735 mV to −745 mV for this alloy. The aluminium alloy of the exchanger tube can in particular have the following composition: Si:≦0.40% by weight, Fe:≦0.7% by weight, Cu:≦0.10% by weight, Mn:≦0.05-0.40% by weight, Zn:≦0.30% by weight, Ti:≦0.10% by weight, impurities individually≦0.05, in total≦0.15, remainder aluminium. 3xxx alloys such as e.g. EN-AW 3102 have a low corrosion potential and are thus vulnerable to corrosion. The use of the previously described alloy for the core layer of the component thus provides significant advantages particularly in combination with exchanger tubes of these alloys.

According to a further embodiment, the brazing material of the common brazed connection of the exchanger tube and the component connected thereto has a Zn content of max. 1.2% by weight, preferably of max. 0.50% by weight, further preferably of max. 0.20% by weight. A brazing material of a standard brazing alloy without Zn, such as for example EN-AW 4043, EN-AW 4045 or, for vacuum brazing, EN-AW 4104 is preferably used. In standard brazing material alloys, the Zn content is limited to values of max. 0.50% by weight, in particular max. 0.20% by weight. In special cases, such as e.g. when using tubes of very low alloyed materials and a corrosion potential brazed of −750 mV and less, the use of a brazing material with an addition of max. 1.2% Zn may be reasonable.

According to a further embodiment, the component connected to the exchanger tube has a clad brazing material layer of a brazing alloy, with the brazing alloy being an aluminium alloy with a Si content of 7 to 12% by weight and with a Zn content of max. 0.50% by weight, in particular max. 0.20% by weight. According to a corresponding embodiment of the use, the aluminium strip has a brazing material layer, clad onto the core layer, of a brazing alloy, with the brazing alloy being an aluminium alloy with a Si content of 7 to 12% by weight and with a Zn content of max. 0.50% by weight, preferably max. 0.20% by weight. According to a corresponding embodiment of the method, the cladding coat consists of a brazing alloy, with the brazing alloy being an aluminium alloy with a Si content of 7 to 12% by weight and with a Zn content of max. 0.50% by weight, preferably max. 0.20% by weight.

Since the corrosion protection of the exchanger tube is ensured by the core layer of the component, the use of Zn-containing brazing materials or Zn-containing brazing material cladding layers can be dispensed with and thus the problem of the uncontrolled Zn diffusion can be avoided.

Further embodiments 1 to 7 of the heat exchanger, further embodiments 8 and 9 of the use and further embodiments 10 to 13 of the method are described below:
1. Heat exchanger, in particular for motor vehicles,
   with at least one exchanger tube made of an aluminium alloy and with at least one component connected in fluid communication to the exchanger tube,
   wherein the exchanger tube and the component are connected to one another by way of a common brazed connection,
   characterised in,
   that the component connected to the exchanger tube has a core layer of an aluminium alloy with the following composition:
      Si: max. 0.70% by weight, preferably 0.50-0.70% by weight,
      Fe: max. 0.70% by weight, preferably max. 0.40% by weight, in particular 0.15-0.40% by weight,
      Cu: max. 0.10% by weight, preferably max. 0.05% by weight,
      Mn: 0.90-1.50% by weight, preferably 1.20 to 1.50% by weight,
      Mg: max. 0.30% by weight, preferably max. 0.10% by weight,
      Cr: max. 0.25% by weight, preferably 0.10 to 0.20% by weight,
      Zn: max. 0.50% by weight, preferably max. 0.10% by weight,
      Ti: max. 0.25% by weight, preferably max. 0.05% by weight,
      Zr: max. 0.25% by weight, preferably max. 0.05% by weight,
      unavoidable impurities individually max. 0.05% by weight, in total max. 0.15% by weight, remainder aluminium.
2. Heat exchanger according to embodiment 1, wherein the component connected to the exchanger tube is a manifold or a tubesheet.
3. Heat exchanger according to embodiment 1 or 2, wherein the component connected to the exchanger tube has a corrosion potential in accordance with ASTM G69 of −740 mV or baser.
4. Heat exchanger according to any one of embodiments 1 to 3, wherein the exchanger tube is an extruded multi-chamber tube.
5. Heat exchanger according to any one of embodiments 1 to 4, wherein the exchanger tube consists of an aluminium alloy of type 3xxx.
6. Heat exchanger according to any one of embodiments 1 to 5, wherein the common brazed connection of the exchanger tube and the component connected thereto was generated using a brazing material which has a Zn content of max. 0.2% by weight.
7. Heat exchanger according to any one of embodiments 1 to 6, wherein the component connected to the exchanger tube has a clad brazing material layer of a brazing alloy, wherein the brazing alloy is an aluminium alloy with a Si content of 7 to 12% by weight and with a Zn content of max. 0.2% by weight.
8. Use of an aluminium alloy or an aluminium strip with a core layer of this aluminium alloy for the production of a component, in particular a manifold or a tubesheet for a heat exchanger, in particular a heat exchanger according to any one of embodiments 1 to 7, wherein the component is designed to be connected in fluid communication to an exchanger tube of the heat exchanger, wherein the aluminium alloy has the following composition:
   Si: max. 0.70% by weight, preferably 0.50-0.70% by weight,
   Fe: max. 0.70% by weight, preferably max. 0.40% by weight, in particular 0.15-0.40% by weight,
   Cu: max. 0.10% by weight, preferably max. 0.05% by weight,
   Mn: 0.90-1.50% by weight, preferably 1.20 to 1.50% by weight,
   Mg: max. 0.30% by weight, preferably max. 0.10% by weight,
   Cr: max. 0.25% by weight, preferably 0.10 to 0.20% by weight,
   Zn: max. 0.50% by weight, preferably max. 0.10% by weight,
   Ti: max. 0.25% by weight, preferably max. 0.05% by weight,
   Zr: max. 0.25% by weight, preferably max. 0.05% by weight,
   unavoidable impurities individually max. 0.05% by weight, in total max. 0.15% by weight, remainder aluminium.
9. Use according to embodiment 8, wherein the aluminium strip has a brazing material layer, clad onto the core layer, of a brazing alloy and wherein the brazing alloy is an aluminium alloy with a Si content of 7 to 12% by weight and with a Zn content of max. 0.2% by weight.
10. Method for the production of an aluminium strip, in particular for the use according to any one of embodiments 8 or 9, with the following steps:
   casting a rolling ingot in the DC method from an aluminium alloy with the following composition:
   Si: max. 0.70% by weight, preferably 0.50-0.70% by weight,
      Fe: max. 0.70% by weight, preferably max. 0.40% by weight, in particular 0.15-0.40% by weight,
      Cu: max. 0.10% by weight, preferably max. 0.05% by weight,
      Mn: 0.90-1.50% by weight, preferably 1.20 to 1.50% by weight,
      Mg: max. 0.30% by weight, preferably max. 0.10% by weight,
      Cr: max. 0.25% by weight, preferably 0.10 to 0.20% by weight,
      Zn: max. 0.50% by weight, preferably max. 0.10% by weight,
      Ti: max. 0.25% by weight, preferably max. 0.05% by weight,
      Zr: max. 0.25% by weight, preferably max. 0.05% by weight,
      unavoidable impurities individually max. 0.05% by weight, in total max. 0.15% by weight, remainder aluminium.
   homogenising the rolling ingot by means of an annealing treatment at a temperature in the range of 540° C. and 600° C. and a hold time at the target temperature between 4 and 12 hours,
   hot rolling the rolling ingot to form a hot strip, in particular to a hot strip thickness in the range of 3 to 7 mm,
   cold rolling the hot strip to a final thickness with optional intermediate annealing at a temperature in the range of 300° C. to 400° C., with the final thickness of the cold strip preferably in the range of 1.0 to 2.5 mm.
11. Method according to embodiment 10 for the production of a roll-clad aluminium strip, in which the rolling ingot is provided with a cladding surface prior to hot rolling.
12. Method according to embodiment 10 or 11, wherein the cladding coat consists of a brazing alloy and wherein the brazing alloy is an aluminium alloy with a Si content of 7 to 12% by weight and with a Zn content of max. 0.2% by weight.
13. Method according to any one of embodiments 10 to 12, wherein the clad cold strip is soft-annealed at final thickness at a temperature in the range of 300° C. and 400° C. or finally annealed at a temperature in the range of 240° C. and 350° C.

Further features and advantages of the heat exchanger, the use and the method can be inferred from the following description of exemplary embodiments, with reference being made to the attached drawing.

### BRIEF DESCRIPTION OF THE SEVERAL VIEWS OF THE DRAWING

In the drawing:

FIGS. 1a and 1b show an exemplary embodiment of the heat exchanger as well as the use of an aluminium alloy or an aluminium strip; and

FIG. 2 shows exemplary embodiments of the method for the production of an aluminium strip.

### DETAILED DESCRIPTION OF THE INVENTION

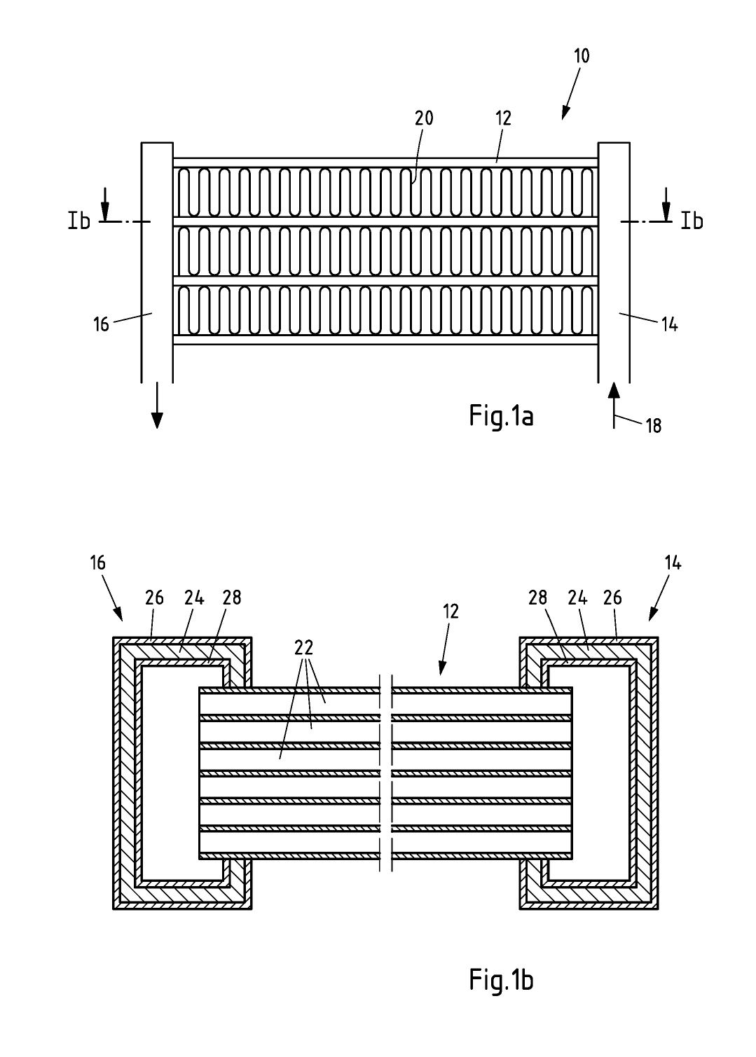

FIGS. 1a and 1b show an exemplary embodiment of the heat exchanger as well as the use of an aluminium alloy or an aluminium strip. FIG. 1a shows a schematic side view of the heat exchanger and FIG. 1b shows a section through the plane designated in FIG. 1a with “1b”.

The heat exchanger 10 has a plurality of exchanger tubes 12, whose ends are in each case connected to a first manifold 14 as well as to a second manifold 16. The manifolds 14, 16 thus in each case constitute a component connected to the exchanger tubes 12.

A medium flow 18 is introduced into the first manifold 14 during operation which is distributed to the exchanger tubes 12 and lastly flows through the manifold 16 out of the heat exchanger 10 again. A second medium flow flows towards the region of the exchanger tubes 12 during operation, said second medium flow comes into thermal contact with the outer surface of the exchanger tubes 12 as a result, such that a heat exchange occurs between the first and the second medium flow. In order to enlarge the surface that can be used for the heat exchange, fins 20 are arranged between the exchanger tubes 12 which are brazed in each case with the exchanger tubes 12.

The exchanger tubes 12 are extruded multi-chamber tubes which have a plurality of channels 22 such that the contact surface between the first medium 18 and the exchanger tubes 12 is increased and the heat exchange is thus improved. The exchanger tubes 12 consists of a low-alloyed aluminium alloy, for example of the type EN-AW 3102 and thus have a rather low corrosion potential.

The manifolds 14, 16 have a multi-layer structure with a core layer 24 and a clad brazing material layer 26. In addition, another clad corrosion protection layer 28 can also be provided on the inside of the manifolds 14, 16. The manifolds 14, 16 can in particular be produced from a clad aluminium strip that has a corresponding structure with a core layer, a clad brazing material layer and, if appropriate, a corrosion protection layer clad on the opposing side of the core layer.

The exchanger tubes 12 are hard-brazed with the manifolds 14, 16, with the material of the brazing material layer 26 acting as a brazing material. The brazing material layer 26 can in particular be an aluminium brazing alloy with a Si content of 7 to 12% by weight.

The exchanger tubes 12 thereby form a coupled galvanic system with the manifolds 14, 16. Heat exchangers from the prior art posed the problem that the exchanger tubes were particularly strongly affected by corrosion due to their low corrosion potential whereby this could prematurely lead to leakages. This problem is remedied with the heat exchanger 10 in that an aluminium alloy with the following composition is used in the present case for the core layer 24 of the manifolds 14, 16:
Si: 0.50-0.7% by weight,
Fe: 0.15-0.40% by weight,
Cu: max. 0.05% by weight, in particular max. 0.03% by weight,
Mn: 1.2 to 1.5% by weight,
Mg: max. 0.10% by weight, in particular 0.01-0.10% by weight,
Cr: 0.10-0.20% by weight,
Zn: max. 0.10% by weight,
Ti: max. 0.25% by weight,
Zr: max. 0.25% by weight,
unavoidable impurities individually max. 0.05% by weight, in total max. 0.15% by weight, remainder aluminium.

Using this alloy composition, the core layer 24 has a lower corrosion potential than the exchanger tubes 12 such that said exchanger tubes are anodically protected by the manifolds 14, 16.

If the heat exchanger 10 is exposed to a corrosion-promoting environment, for example in the engine compartment of a motor vehicle, the corrosion firstly attacks the manifolds 14 and 16 and possibly the fins 20, while the exchanger tubes 12 that are more critical for the operation of the heat exchanger 10 are subjected only to low corrosion. As a result, the service life of the heat exchanger 10 can be extended.

Using the anodic protection of the exchanger tubes 12 by way of the manifolds 14, 16, the use of Zn-containing brazing materials, which were used in the prior art partly as corrosion protection for the exchanger tubes, can in particular also be dispensed with. The aluminium brazing alloy of the brazing material layer 26 accordingly preferably has a Zn content of max. 0.50% by weight, further preferably of max. 0.20% by weight. Diffusion of Zn in the heat exchanger which is difficult to control can hereby be prevented.

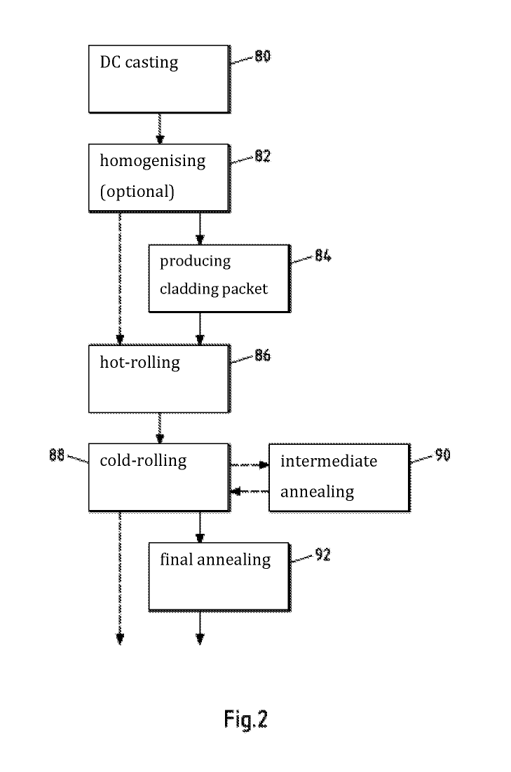

FIG. 2 shows an exemplary embodiment of a method for the production of an aluminium strip which can be used in particular for the production of the manifolds 14, 16 from FIGS. 1a and 1b.

In a first step 80, an alloy of the above-mentioned composition is cast for the core layer 24 in the DC method to form a rolling ingot. This rolling ingot is homogenised in a subsequent step 82 at a temperature in the range of 540° C. and 600° C. and a hold time at the target temperature of 4 to 12 hours. In an alternative exemplary embodiment of the method, the homogenisation step 82 can also be omitted.

If a clad aluminium strip is supposed to be produced, for example with a brazing material layer and/or a corrosion protection layer, a cladding packet is produced in a subsequent step 84 from the rolling ingot as the core layer and one or a plurality of cladding layers arranged over or under the core layer. The thickness of the cladding layers are in each case preferably between 5 and 20% of the overall thickness of the cladding packet.

The rolling ingot or the cladding packet is hot-rolled in a subsequent step 86, in particular to a thickness in the range of 3-7 mm. The rolling ingot or the cladding packet is pre-heated prior to the hot-rolling and preferably to a temperature in the range of 450-480° C. with a hold time at the target temperature of 3-10 h.

The possibly roll-clad hot strip is cold-rolled in a subsequent step 88, preferably to a final thickness of 1.0 to 2.5 mm. Intermediate annealing (recrystallisation annealing) can be carried out in an intermediate step 90 during the cold rolling at an intermediate thickness, preferably at a temperature in the range of 300 and 400° C.

After the cold rolling to the final thickness, a final annealing can optionally be carried out in a subsequent step 92. By way of soft-annealing at a temperature in the range 300-400° C., a material in the soft-annealed state O can be thereby achieved. Alternatively, a final annealing can also take place for a material in the state H24 at a temperature in the range 240-350° C.

Tests were carried out from which emerge the desired combination of a low corrosion potential with simultaneously good strength for components of the described alloy.

TABLE 1

| Alloy | Si | Fe | Cu | Mn | Mg | Cr | Zn | Ti | Zr | Al |
|---|---|---|---|---|---|---|---|---|---|---|
| A | 0.64 | 0.31 | 0.00 | 1.40 | 0.08 | 0.13 | 0.005 | 0.008 | — | Remainder |
| B | 0.62 | 0.26 | 0.00 | 1.37 | 0.20 | 0.00 | 0.001 | 0.006 | — | Remainder |
| C | 0.50 | 0.30 | 0.27 | 1.09 | 0.27 | 0.20 | 0.001 | 0.007 | — | Remainder |
| D | 0.59 | 0.29 | 0.00 | 1.34 | 0.06 | 0.13 | 0.01 | — | — | Remainder |
| E | 0.60 | 0.28 | 0.02 | 1.41 | 0.06 | 0.12 | 0.00 | — | — | Remainder |
| F | 0.59 | 0.30 | 0.00 | 1.35 | 0.07 | 0.12 | 0.01 | — | — | Remainder |
| EN-AW 4045 | 9.87 | 0.21 | 0.00 | 0.01 | 0.01 | 0.00 | 0.005 | 0.005 | — | Remainder |

Table 1 shows the alloy compositions used in the tests (all weight information in % by weight). The alloys A and B from Table 1 are in accordance with the invention, with the alloy A corresponding to a preferred embodiment of the invention. Alloy C is a comparative alloy which is used as the core alloy in the heat exchanger field. The alloys D to F are in turn in accordance with the invention and correspond to a preferred embodiment of the invention. The brazing alloy of type EN-AW 4045 also indicated was used in the tests A-C and F for the brazing material cladding layer.

Roll-clad aluminium strips were produced using the method represented in FIG. 2, with the alloys A, B, C, D, E and F in each case having been used for the core layer and the alloy of type EN-AW 4045 mentioned in Table 1 in each case for the brazing material cladding coats in tests A, B, C and F. In the tests D and E, an alternative alloy of the type EN-AW 4343 was in each case used for the brazing material cladding coats, with 1% by weight of Zn also having been added to the brazing alloy in test E.

In the cases A-C, 60 kg batches of the alloys in question were in each case produced and cast in the DC casting method to form ingots in the cross section 335 mm×125 mm. In the cases D-F, batches of a number of tones of the alloy in question were in each case produced and cast in the DC casting process to form larger bars (cross section approx. 500×approx. 1500 mm). For the production of strip material, a brazing material ingot EN-AW 4045 or EN-AW 4343, respectively, was firstly rolled to the required thickness for a cladding layer of 7.5% of the total thickness. The core bars of the alloys A, B, C or D were subjected to homogenisation at a temperature of 575° C. and the core bars of the alloys E and F were subjected to homogenisation at a temperature of 600° C. for a hold time of 6 h. Cladding packets with a one-sided brazing material coat of 7.5% of the total thickness were produced thereafter with the pre-rolled brazing material coat. These were in each case pre-heated with a temperature of 470° C. and a hold time of at least 3 h and then hot-rolled to a thickness of 7.0 mm.

Cold-rolling with a plurality of passes to a final thickness of 1.5 mm (tests A-C and E) or 1.0 mm (test D) or 1.6 mm (test F) followed in each case. Soft-annealing to set a temper 0 state at a temperature of 350° C. (for the strips with the core layer alloys A and B) or of 320° C. (for the strip with the core layer alloy C) or of 400° C. (for the strips with the core layer alloys D to F) was then carried out, in each case with a hold time of 2 h.

From the strips with core layer alloys A and B, a strip section in each case with an intermediate thickness of 2.15 mm was also subjected to soft-annealing at 350° C. and a hold time of 2 h and then cold-rolled with a final reduction rolling degree of 30% to a final thickness of 1.5 mm in the temper state H14.

Samples were taken from the brazing material-clad strips produced in this way and subjected to brazing simulation in each case to test the properties in the brazed state which corresponds to a typical industrial brazing cycle. The samples were, for this purpose, heated at a heating rate of 0.9° C./s to a temperature of 600° C. and cooled after a hold time of 5 mins at a rate of 0.9° C./s.

The mechanical properties of the strips were determined on the samples. The measurement of the mechanical properties was in each case carried out prior to and after the brazing simulation and in each case in the rolling direction.

Table 2 below shows the results of the measurements of the mechanical properties. The first column indicates in each case the alloy composition of the core layer, the second column indicates in each case the state of the roll-clad strip from which the respective sample was taken. R_{p0.2}, Rₘ, A_{g} and A₅₀ₘₘ were in each case determined according to DIN EN ISO 6892-1/A224.

TABLE 2

| | | | R_{p0.2} | | | |
|---|---|---|---|---|---|---|
| | | Thickness | [N/ | Rₘ | A_{g} | A_{50 mm} |
| Sample | State | [mm] | mm²] | [N/mm²] | [%] | [%] |
| A | Prior to brazing | 1.5 | 52 | 127 | 19.9 | 26.0 |
| | simulation | | | | | |
| | O temper | | | | | |
| A | Prior to brazing | 1.5 | 165 | 179 | 1.9 | 5.5 |
| | simulation | | | | | |
| | H14 | | | | | |
| B | Prior to brazing | 1.5 | 52 | 128 | 20.2 | 26.4 |
| | simulation | | | | | |
| | O temper | | | | | |
| B | Prior to brazing | 1.5 | 169 | 179 | 1.7 | 5.1 |
| | simulation | | | | | |
| | H14 | | | | | |
| C | Prior to brazing | 1.5 | 68 | 152 | 17.8 | 22.4 |
| | simulation | | | | | |
| | O temper | | | | | |
| A | After brazing | 1.5 | 47 | 129 | 18.6 | 22.9 |
| | simulation | | | | | |
| | O temper | | | | | |
| A | After brazing | 1.5 | 46 | 130 | 19.0 | 23.1 |
| | simulation | | | | | |
| | H14 | | | | | |
| B | After brazing | 1.5 | 47 | 134 | 14.9 | 15.7 |
| | simulation | | | | | |
| | O temper | | | | | |
| B | After brazing | 1.5 | 47 | 138 | 18.2 | 21.3 |
| | simulation | | | | | |
| | H14 | | | | | |
| C | After brazing | 1.5 | 51 | 148 | 14.8 | 20.7 |
| | simulation | | | | | |
| | O temper | | | | | |
| D | Prior to brazing | 1.0 | 52 | 125 | 21.3 | 31.6 |
| | simulation | | | | | |
| | O temper | | | | | |
| D | After brazing | 1.0 | 49 | 142 | 17.2 | 19.6 |
| | simulation | | | | | |
| | O temper | | | | | |
| E | Prior to brazing | 1.5 | 52 | 121 | 22.5 | 33.8 |
| | simulation | | | | | |
| | O temper | | | | | |
| E | After brazing | 1.5 | 45 | 132 | 20.2 | 25.6 |
| | simulation | | | | | |
| | O temper | | | | | |
| F | Prior to brazing | 1.6 | 49 | 121 | 22.4 | 33.5 |
| | simulation | | | | | |
| | O temper | | | | | |
| F | After brazing | 1.6 | 47 | 129 | N/A | N/A |
| | simulation | | | | | |
| | O temper | | | | | |

The results in Table 2 show that comparable strengths can be achieved with the alloy according to the invention (samples A and B as well as D to F) as with standard alloys (sample C).

Corrosion tests were also carried out on the samples. To this end, the electrochemical corrosion potential was firstly measured in accordance with ASTM G69 against a saturated calomel electrode in an electrolyte of neutral 1 mole NaCl solution. The corrosion potential was in each case measured at the core layer.

The results of the measurements are reproduced in Table 3 below. The measurement was carried out in each case prior to and after the above-described brazing simulation.

TABLE 3

| | | Corrosion potential prior | Corrosion potential |
|---|---|---|---|
| | | to brazing simulation | after brazing |
| Sample | Temper state | [mV] | simulation [mV] |
| A | O | −773 | −759 |
| A | H14 | −772 | −759 |
| B | O | −772 | −758 |
| B | H14 | −770 | −761 |
| C | O | −746 | −727 |
| D | O | −759 | −742 |
| E | O | −784 | −757 |
| F | O | −760 | −747 |

The samples A and B as well as D to F deliver comparably good values for the corrosion potential. The proposed aluminium alloy with the lower Mg content of max. 0.10% by weight (corresponding to samples A and D to F) is preferred since an impairment of the brazeability in the CAB brazing process by a higher proportion of Mg can thereby be prevented. Similarly, a proportion of Mg of 0.04% by weight or more is preferred in order to thereby be able to better set the desired strength and the desired corrosion potential of the alloy. The sample corresponding to the comparative alloy C exhibits a corrosion potential clearly outside of the desired range.

An advantage of the alloy proposed for the core alloy is in particular the galvanic compatibility with typical alloys for exchanger tubes, in particular MPEs. In order to verify this galvanic compatibility, contact corrosion measurements were carried out in accordance with DIN 50919. For these measurements, the samples A, B and C were brought into contact in each case in an electrolyte with samples K from an extruded tube of the frequently used alloy EN-AW 3102. An acidified synthetic saline solution with a pH value between 2.8 and 3.0 in accordance with testing standard ASTM G85, Annex A3 was used as the electrolyte. Prior to the measurement, the samples A, B, C and K were in each case subjected to the above-described brazing simulation. The samples K of EN-AW 3102 have a corrosion potential in accordance with ASTM G69 of −742 mV in the braze-simulated state.

The contact corrosion measurement in accordance with DIN 50919 was carried out with the sample A, B and C on the unclad side, i.e. directly on the core layer. The galvanic compatibility was in each case assessed based on the direction of the measured current flow. Compatibility is then present when the current flow takes place from the sample for the component of the heat exchanger, e.g. of the tubesheet or of the manifold, towards the material of the exchanger tube, in particular the MPEs. In this case, the component (tubesheet/manifold) preferably dissolves and sacrifices itself for the exchanger tube (MPE).

In the case of the contact corrosion measurements, the combination of the sample A (O temper) with a sample K resulted in a mass loss of the sample K of 1.6 g/m² and the combination of the sample B (O temper) with a sample K resulted in a mass loss of the sample K of 3.9 g/m². In contrast, the mass loss of the sample K for the combination of the sample C (O temper) with a sample K was 34.4 g/m². The samples A and B accordingly had a significantly better galvanic compatibility with the sample K than the comparative sample C, i.e. the corrosion of the sample K was significantly reduced by the combination with one of the samples A or B.

In conclusion, the previously described tests show that by using the alloy, which is proposed in the present case for the core layers of components connected to exchanger tubes, anodic protection of the exchanger tubes can be achieved such that the service life of the heat exchanger is notably extended. The corresponding components also have sufficient strength.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A heat exchanger, in particular for motor vehicles,
with at least one exchanger tube made of an aluminium alloy and with at least one component connected in fluid communication to the exchanger tube,
wherein the exchanger tube and the component are connected to one another by way of a common brazed connection,
wherein the component connected to the exchanger tube has a core layer of an aluminium alloy with the following composition:
Si: max. 0.7% by weight,
Fe: max. 0.7% by weight,
Cu: max. 0.10% by weight,
Mn: 0.9-1.5% by weight,
Mg: max. 0.30% by weight,
Cr: max. 0.25% by weight,
Zn: max. 0.50% by weight,
Ti: max. 0.25% by weight,
Zr: max. 0.25% by weight,
unavoidable impurities individually max. 0.05% by weight, in total max. 0.15% by weight, remainder aluminium.

2. The heat exchanger according to claim 1, wherein the aluminium alloy of the core layer has the following composition:
Si: 0.50-0.7% by weight,
Fe: 0.15-0.40% by weight,
Cu: max. 0.03% by weight,
Mn: 1.2 to 1.5% by weight,
Mg: 0.01-0.10% by weight,
Cr: 0.10-0.20% by weight,
Zn: max. 0.10% by weight,
Ti: max. 0.25% by weight,
Zr: max. 0.25% by weight,
unavoidable impurities individually max. 0.05% by weight, in total max. 0.15% by weight, remainder aluminium.

3. The heat exchanger according to claim 1, wherein the aluminium alloy of the core layer has a ratio of the Mn content to the Si content in the range of 1.7 to 3.

4. The heat exchanger according to claim 1, wherein the component connected to the exchanger tube is a manifold or a tubesheet.

5. The heat exchanger according to claim 1, wherein the component connected to the exchanger tube has a corrosion potential in accordance with ASTM G69 of −740 mV or baser.

6. The heat exchanger according to claim 1, wherein the exchanger tube is an extruded multi-chamber tube.

7. The heat exchanger according to claim 1, wherein the exchanger tube consists of an aluminium alloy of the type 3xxx.

8. The heat exchanger according to claim 1, wherein the common brazed connection of the exchanger tube and the component connected thereto was produced using a brazing material which has a Zn content of max. 0.50% by weight.

9. The heat exchanger according to claim 1, wherein the component connected to the exchanger tube has a clad brazing material layer of a brazing alloy, wherein the brazing alloy is an aluminium alloy with a Si content of 7 to 12% by weight and with a Zn content of max. 0.50% by weight.

10. A component, in particular a manifold or a tubesheet for a heat exchanger, produced from an aluminium alloy or an aluminium strip with a core layer of an aluminium alloy, wherein the component is designed to be connected in fluid communication to an exchanger tube of a heat exchanger, wherein the aluminium alloy has the following composition:
Si: max. 0.7% by weight,
Fe: max. 0.7% by weight,
Cu: max. 0.10% by weight,
Mn: 0.9-1.5% by weight,
Mg: max. 0.30% by weight,
Cr: max. 0.25% by weight,
Zn: max. 0.50% by weight,
Ti: max. 0.25% by weight,
Zr: max. 0.25% by weight,
unavoidable impurities individually max. 0.05% by weight, in total max. 0.15% by weight, remainder aluminium.

11. The component of claim 10, wherein the component is produced from the aluminium strip with a core layer of the aluminium alloy, wherein the aluminium strip has a brazing material layer, clad onto the core layer of a brazing alloy, and wherein the brazing alloy is an aluminium alloy with an Si content of 7 to 12% by weight and with a Zn content of max. 0.50% by weight.

12. A method for the production of an aluminium strip, with the following steps:
casting a rolling ingot in the DC method from an aluminium alloy with the following composition:
Si: max. 0.7% by weight,
Fe: max. 0.7% by weight,
Cu: max. 0.10% by weight,
Mn: 0.9-1.5% by weight,
Mg: max. 0.30% by weight,
Cr: max. 0.25% by weight,
Zn: max. 0.50% by weight,
Ti: max. 0.25% by weight,
Zr: max. 0.25% by weight,
unavoidable impurities individually max. 0.05% by weight, in total max. 0.15% by weight, remainder aluminium.
optionally homogenising the rolling ingot by means of an annealing treatment at a temperature in the range of 540° C. and 620° C. and a hold time at the target temperature between 4 and 12 hours,
hot rolling the rolling ingot to form a hot strip, in particular to a hot strip thickness in the range of 2.0 to 10 mm,
cold rolling the hot strip to a final thickness with optional intermediate annealing at a temperature in the range of 300° C. to 450° C. to form a cold strip, wherein the final thickness of the cold strip is in the range of 0.1 to 5 mm.

13. The method according to claim 12, wherein the method produces a roll-clad aluminium strip,
in which the rolling ingot is provided with a cladding coat prior to hot rolling.

14. The method according to claim 13, wherein the cladding coat consists of a brazing alloy, wherein the brazing alloy is an aluminium alloy with a Si content of 7 to 12% by weight and with a Zn content of max. 0.50% by weight.

15. The method according to claim 13, wherein, after cold rolling, the roll-clad aluminium strip is soft-annealed at final thickness at a temperature in the range of 300° C. and 450° C. or finally annealed at a temperature in the range of 240° C. and 350° C.
